(19) United States
(12) Patent Application Publication
(10) Pub. No.: US 2009/0311033 A1
(43) Pub. Date: Dec. 17, 2009

(54) Multifunctional Bath Product

(76) Inventor: Chiu-Fu Lin, Sanchong City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/139,644

(22) Filed: Jun. 16, 2008

(51) Int. Cl. A46B 5/02; B43K 5/00; A47K 7/02

(52) U.S. Cl. 401/201; 401/8; 401/6; 401/196; 15/210.1

(57) ABSTRACT

A bath product includes a flexible main body having an inside provided with a receiving space to receive a soap and a side provided with an entrance connected to the receiving space. Thus, the main body can co-operate with the body lotion or the soap to clean a user's body. In addition, when the main body is combined with the soap, a large number of bubbles are produced by the three-dimensional multi-layer porous hollow structure of the main body to clean the user's body easily and quickly. Further, the residual water contained in the main body is drained quickly by the three-dimensional multi-layer porous hollow structure of the main body, thereby enhancing the drying effect of the main body.

### BACKGROUND OF THE INVENTION

1. Field of the Invention

The present invention relates to a bath product or accessory and, more particularly, to a multifunctional bath product.

2. Description of the Related Art

A conventional bath product in accordance with the prior art shown in FIG. 12 comprises a soap dish 2 and a soap 1 placed on the soap dish 2. However, a determined amount of residual water is deposited on the soap dish 2 after usage, so that the soap 1 is immersed in the residual water of the soap dish 2, thereby easily incurring a sanitary problem.

Another conventional bath product in accordance with the prior art shown in FIG. 13 is an elongate bath towel and comprises a plurality of oblong balls 3 which are connected serially. However, a user has to wet the oblong balls 3 and to rub the oblong balls 3 with a soap or body lotion so as to produce bubbles for cleaning his/her body, thereby causing inconvenience to the user.

### BRIEF SUMMARY OF THE INVENTION

In accordance with the present invention, there is provided a bath product, comprising a flexible main body having an inside provided with a receiving space to receive a soap and a side provided with an entrance connected to the receiving space.

The primary objective of the present invention is to provide a bath product having multiple functions.

Another objective of the present invention is to provide a bath product, wherein the main body can co-operate with the body lotion or the soap so as to clean a user's body, thereby enhancing the versatility of the bath product.

A further objective of the present invention is to provide a bath product, wherein when the main body is combined with the soap, the main body produces a large number of bubbles by the three-dimensional multi-layer porous hollow structure of the main body so as to clean the user's body easily and quickly.

A further objective of the resent invention is to provide a bath product, wherein the residual water contained in the main body is drained outwardly easily and quickly by the three-dimensional multi-layer porous hollow structure of the main body, thereby enhancing the drying effect of the main body when not in use.

A further objective of the present invention is to provide a bath product, wherein the covering bag is enclosed around the outer surface of the main body to cover and protect the main body, thereby enhancing the lifetime of the main body.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a bath product in accordance with the preferred embodiment of the present invention.

FIG. 2 is a side cross-sectional view of the bath product as shown in FIG. 1.

FIG. 3 is a schematic perspective operational view of the bath product as shown in FIG. 1.

FIG. 4 is a schematic side operational view of the bath product as shown in FIG. 1.

FIG. 5 is a schematic perspective operational view of the bath product as shown in FIG. 3.

FIG. 6 is a perspective view of a bath product in accordance with another preferred embodiment of the present invention.

FIG. 7 is a perspective view of a bath product in accordance with another preferred embodiment of the present invention.

FIG. 8 is a perspective view of a bath product in accordance with another preferred embodiment of the present invention.

FIG. 9 is a perspective view of a bath product in accordance with another preferred embodiment of the present invention.

FIG. 10 is a perspective view of a bath product in accordance with another preferred embodiment of the present invention.

FIG. 11 is a perspective view of a bath product in accordance with another preferred embodiment of the present invention.

FIG. 12 is a perspective view of a conventional bath product in accordance with the prior art.

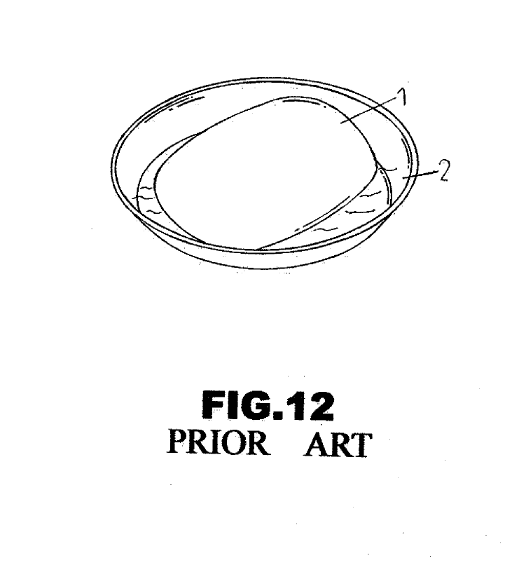

FIG. 13 is a perspective view of another conventional bath product in accordance with the prior art.

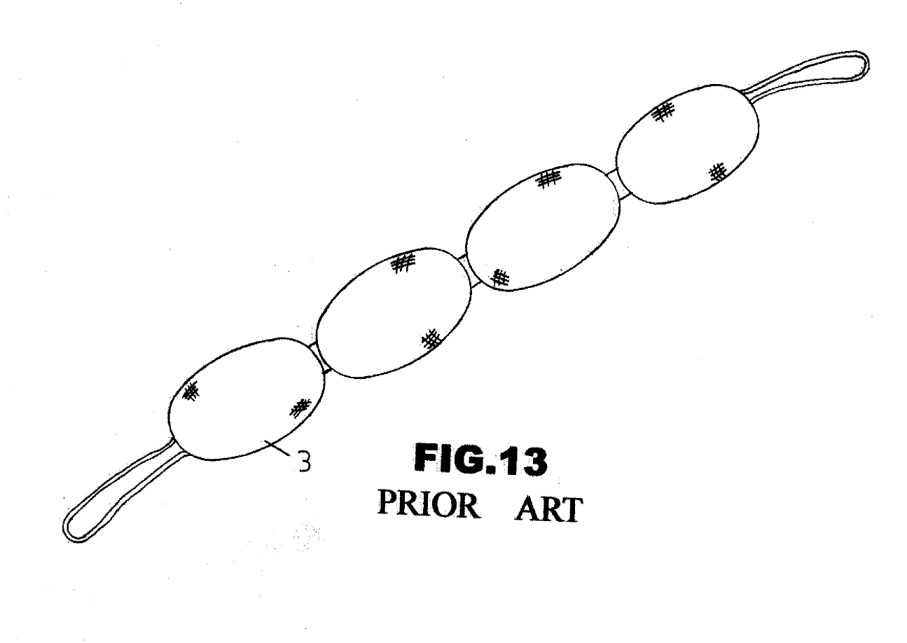

### DETAILED DESCRIPTION OF THE INVENTION

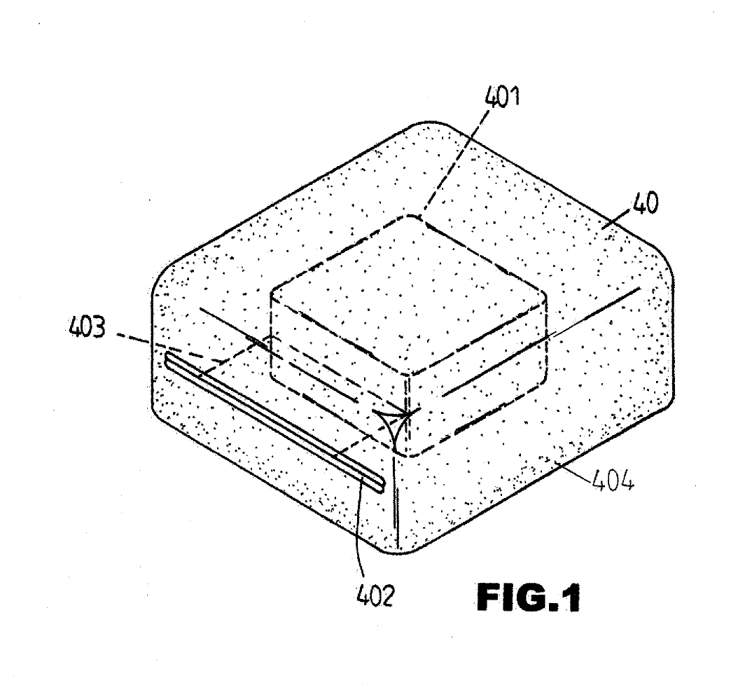

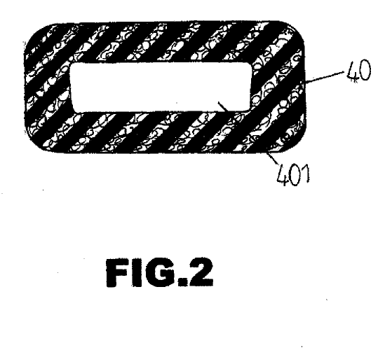

Referring to the drawings and initially to FIGS. 1 and 2, a bath product in accordance with the preferred embodiment of the present invention comprises a flexible main body 40 having an inside provided with a receiving space 401 and a side provided with an entrance 403 connected to the receiving space 401.

The main body 40 has a three-dimensional multi-layer porous hollow structure and has a water permeable feature. Preferably, the main body 40 is made of hydrophilic material, such as sponge. Alternatively, the main body 40 is made of non-hydrophilic material, such as a polyester fiber, an artificial fiber, a silicon gel and the like. In addition, the main body 40 has a square shape, and the receiving space 401 of the main body 40 also has a square shape.

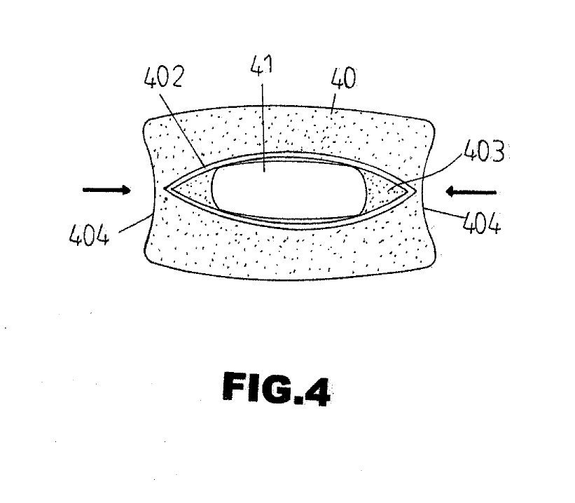

The entrance 403 of the main body 40 is located between two opposite ends 404 of the main body 40 so that the entrance 403 is expandable outwardly when the two opposite ends 404 of the main body 40 are compressed toward each other as shown in FIG. 4. The entrance 403 of the main body 40 has an open distal end provided with a closing member 402 which is expandable outwardly when the two opposite ends 404 of the main body 40 are compressed toward each other. Preferably, the closing member 402 of the entrance 403 of the main body 40 is an elastic clip.

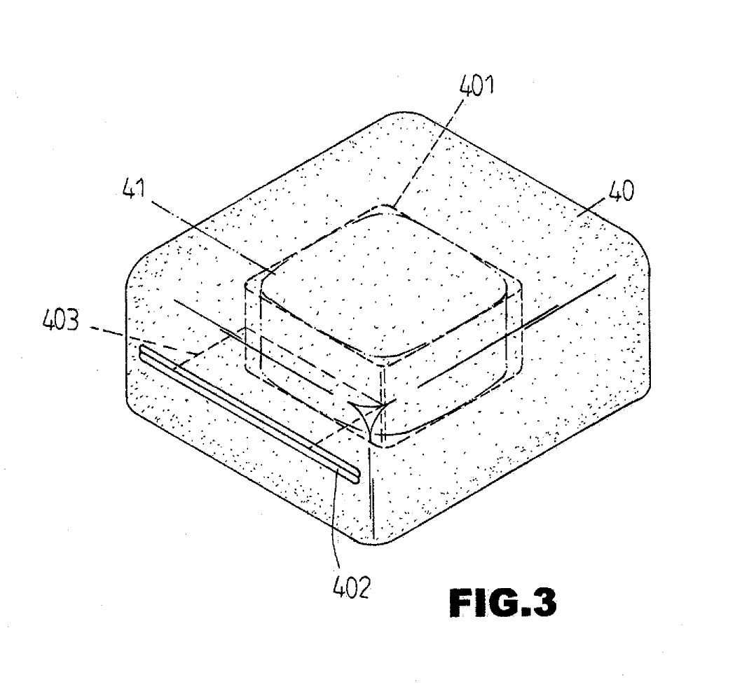

In operation, referring to FIGS. 3 and 4 with reference to FIGS. 1 and 2, the closing member 402 is expanded outwardly when the two opposite ends 404 of the main body 40 are compressed toward each other so that the entrance 403 of the main body 40 is opened. In such a manner, a soap 41 is inserted through the entrance 403 into the receiving space 401 of the main body 40, so that the main body 40 is combined with the soap 41 to form a bath block which is wet by water so as to clean a user's body.

Alternatively, when the soap 41 is removed from the receiving space 401 of the main body 40, the main body 40 is used individually to combine with body lotion and water so as to clean a user's body.

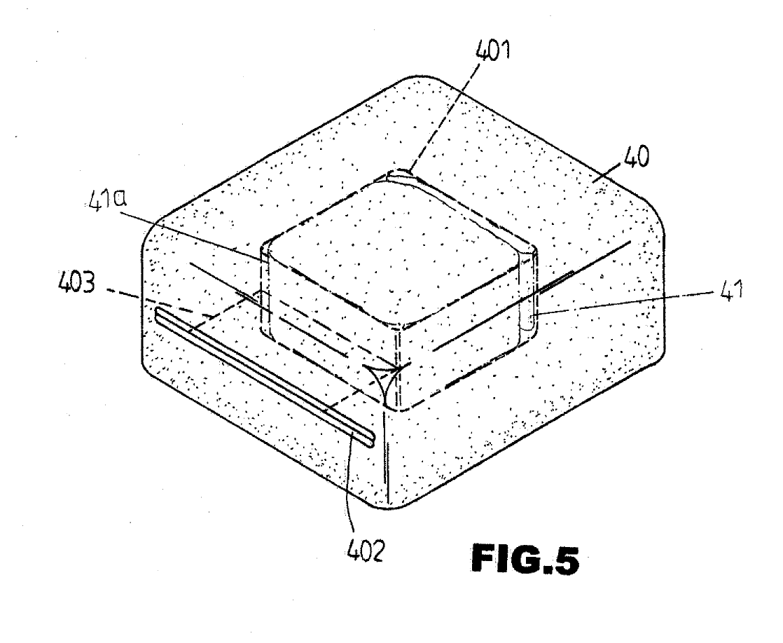

As shown in FIG. 5, when the soap 41 is almost used up, a new soap 41a is directly inserted through the entrance 403 into the receiving space 401 of the main body 40 to abut the soap 41, so that the soap 41 and the new soap 41a are combined together.

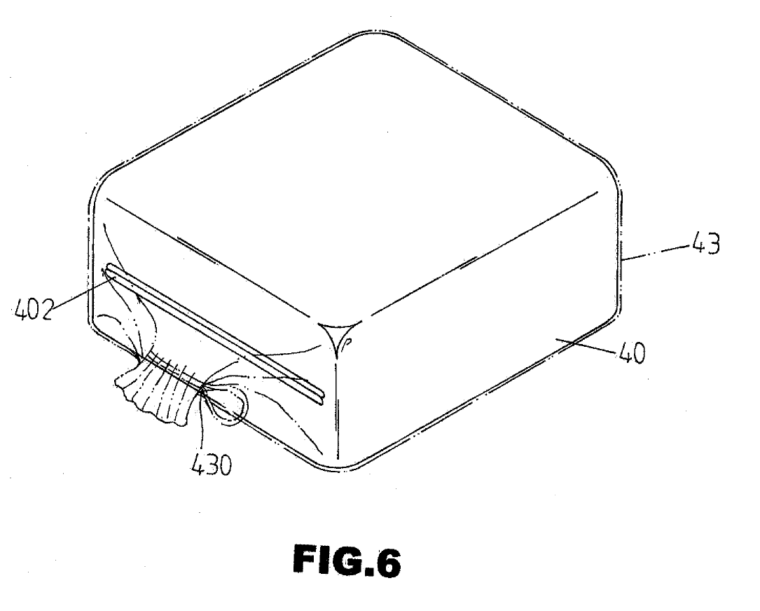

Referring to FIG. 6, the bath product further comprises a covering bag 43 enclosed around an outer surface of the main body 40 to cover and protect the main body 40. The covering bag 43 is made of a water permeable cloth and has an open side provided with a binding member 430 aligning with the closing member 402 of the main body 40. Preferably, the binding member 430 of the covering bag 43 is a binding strap.

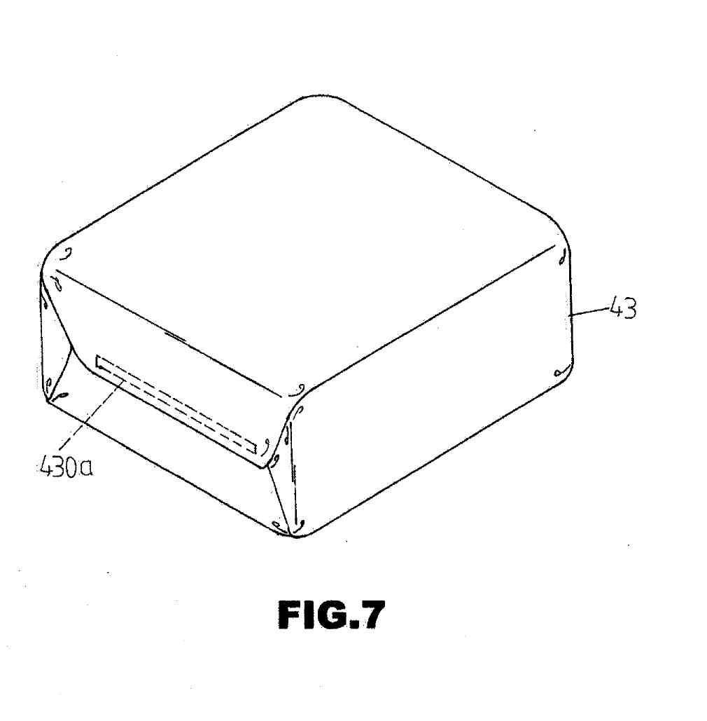

As shown in FIG. 7, the binding member 430a of the covering bag 43 is a hooked-and-looped bonding device (or magic Velcro strap).

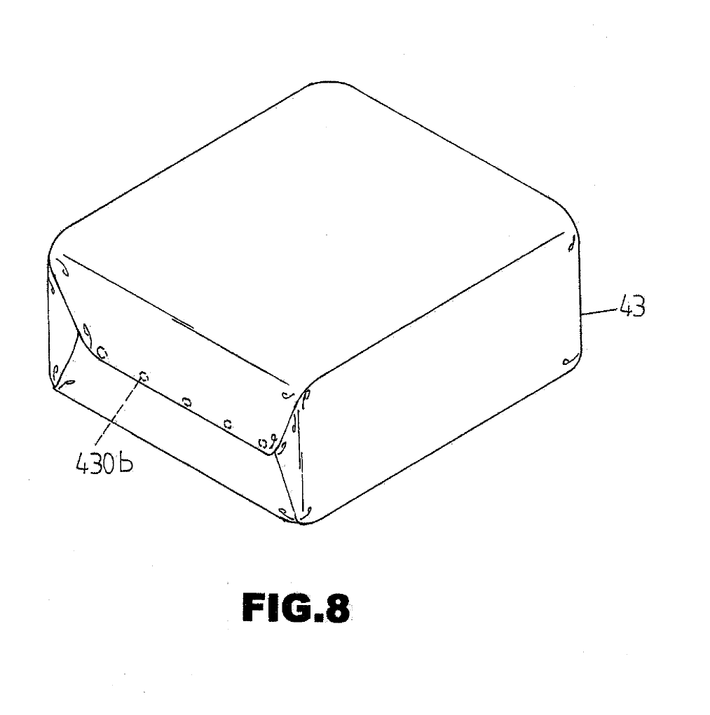

As shown in FIG. 8, the binding member 430b of the covering bag 43 is a snap-type bonding device.

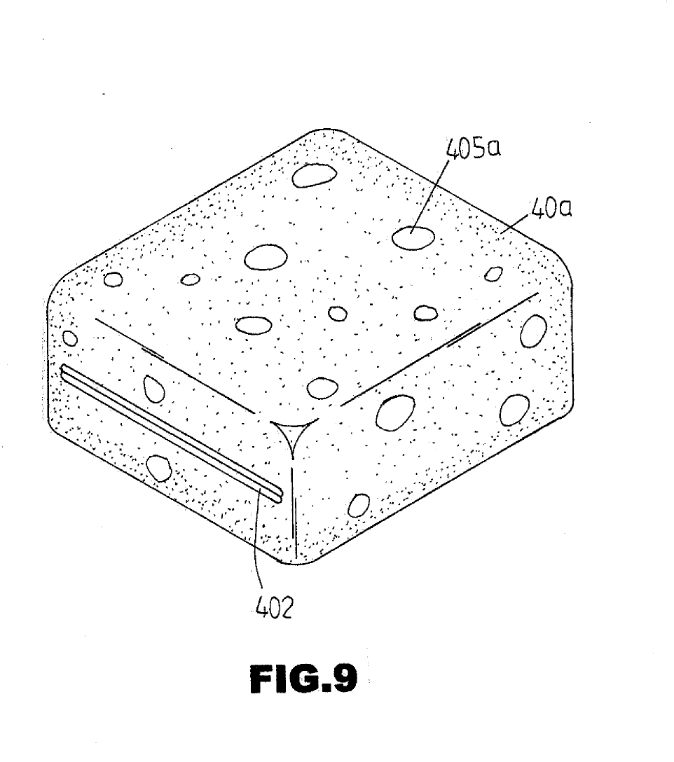

As shown in FIG. 9, the main body 40a is provided with a plurality of pores 405a.

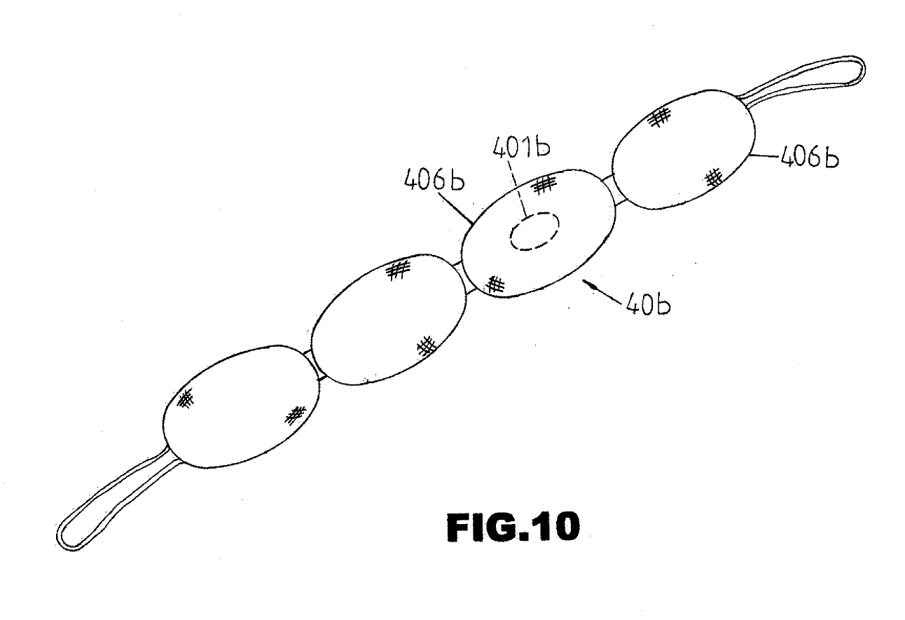

As shown in FIG. 10, the main body 40b is provided with a plurality of oblong members 406b which are connected serially, wherein at least one of the oblong members 406b has an inside provided with the receiving space 401b.

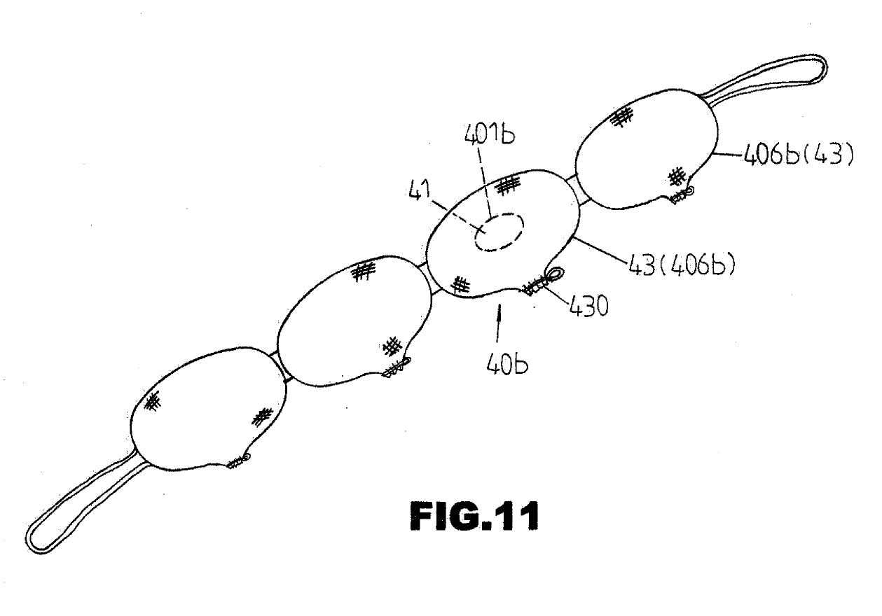

As shown in FIG. 11, the bath product further comprises a plurality of covering bags 43 enclosed around an outer surface of each of the oblong members 406b of the main body 40b to cover and protect each of the oblong members 406b of the main body 40b.

Accordingly, the main body 40 can co-operate with the body lotion or the soap 41 so as to clean a user's body, thereby enhancing the versatility of the bath product. In addition, when the main body 40 is combined with the soap 41 to form a bath block, the main body 40 produces a large number of bubbles by the three-dimensional multi-layer porous hollow structure of the main body 40 so as to clean the user's body easily and quickly. Further, the residual water contained in the main body 40 is drained easily and quickly by the three-dimensional multi-layer porous hollow structure of the main body 40, thereby enhancing the drying effect of the main body 40 when not in use. Further, the covering bag 43 is enclosed around the outer surface of the main body 40 to cover and protect the main body 40, thereby enhancing the lifetime of the main body 40.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A bath product, comprising:
a flexible main body having an inside provided with a receiving space and a side provided with an entrance connected to the receiving space.

2. The bath product in accordance with claim 1, wherein the main body has a three-dimensional multi-layer porous hollow structure.

3. The bath product in accordance with claim 1, wherein the main body has a water permeable feature.

4. The bath product in accordance with claim 1, wherein the main body has a square shape.

5. The bath product in accordance with claim 1, wherein the receiving space of the main body has a square shape.

6. The bath product in accordance with claim 1, wherein the entrance of the main body has an open distal end provided with a closing member.

7. The bath product in accordance with claim 6, wherein
the entrance of the main body is located between two opposite ends of the main body;
the entrance is expandable outwardly when the two opposite ends of the main body are compressed toward each other.

8. The bath product in accordance with claim 7, wherein the closing member of the entrance of the main body is expandable outwardly when the two opposite ends of the main body are compressed toward each other to open the entrance of the main body.

9. The bath product in accordance with claim 6, wherein the closing member of the entrance of the main body is an elastic clip.

10. The bath product in accordance with claim 6, further comprising:
a covering bag enclosed around an outer surface of the main body to cover and protect the main body.

11. The bath product in accordance with claim 10, wherein the covering bag is made of a water permeable cloth.

12. The bath product in accordance with claim 10, wherein the covering bag has an open side provided with a binding member aligning with the closing member of the main body.

13. The bath product in accordance with claim 12, wherein the binding member of the covering bag is a binding strap.

14. The bath product in accordance with claim 12, wherein the binding member of the covering bag is a hooked-and-looped bonding device.

15. The bath product in accordance with claim 12, wherein the binding member of the covering bag is a snap-type bonding device.

16. The bath product in accordance with claim 1, wherein the main body is provided with a plurality of pores.

17. The bath product in accordance with claim 1, wherein
the main body is provided with a plurality of oblong members which are connected serially;
at least one of the oblong members has an inside provided with the receiving space.

18. The bath product in accordance with claim 17, further comprising:
a plurality of covering bags enclosed around an outer surface of each of the oblong members of the main body to cover and protect each of the oblong members of the main body.
